(19) United States
(12) Patent Application Publication
(10) Pub. No.: US 2026/0129526 A1
(43) Pub. Date: May 7, 2026

(54) CONDITIONAL ACCESS

(71) Applicant: Nokia Technologies Oy, Espoo (FI)

(72) Inventors: Ahmad AWADA, Munich (DE); Irina-Mihaela BALAN, Munich (DE); Ugur Baran ELMALI, Munich (DE); Guillaume DECARREAU, Munich (DE); Bernhard WEGMANN, Munich (DE)

(21) Appl. No.: 19/118,421

(22) PCT Filed: Oct. 4, 2023
(86) PCT No.: PCT/EP2023/077404

§ 371 Date: Apr. 4, 2025

(30) Foreign Application Priority Data
Oct. 10, 2022 (GB) 2214898.5

(51) Int. Cl. H04W 36/00; H04W 36/30; H04W 36/36

(52) U.S. Cl. CPC H04W 36/0061; H04W 36/0069; H04W 36/00835; H04W 36/305; H04W 36/362

(57) ABSTRACT

An apparatus comprising means for: receiving secondary radio link failure information, wherein the secondary radio link failure information is indicative of circumstances of a failure in a secondary node while the user equipment was configured to conditionally access at least one target secondary node, and the user equipment is having dual connectivity with a source master node and a source secondary node; determining a plurality of suggested target primary cells of a secondary cell group to be prepared by the at least one target secondary node for conditional access by a user equipment; determining, based at least in part on the received secondary radio link failure information, assistance information, wherein the assistance information assists the at least one target secondary node in determining which at least one of the plurality of suggested target primary cells of a secondary cell group is to be prepared by the at least one target secondary node for conditional access by a user equipment; and transmitting, directly or indirectly, information indicative of the plurality of suggested target primary cells of a secondary cell group and the determined assistance information to the at least one target secondary node.

### TECHNOLOGICAL FIELD

Examples of the disclosure relate to conditional access. Some relate to conditional access of a target secondary node.

### BACKGROUND

A wireless network comprises a plurality of network nodes including terminal nodes and access nodes. Communication between the terminal nodes and access nodes is wireless.

In some circumstances it may be desirable to improve or enhance conditional access, by a terminal node, of a target secondary node.

### BRIEF SUMMARY

According to various, but not necessarily all, embodiments there is provided an apparatus comprising means for:
receiving secondary radio link failure information, wherein the secondary radio link failure information is indicative of circumstances of a failure in a secondary radio link between a user equipment and at least one source secondary node while the user equipment was configured to conditionally access at least one target secondary node, and the user equipment is having dual connectivity with a source master node and a source secondary node;
determining a plurality of suggested target primary cells of a secondary cell group to be prepared by the at least one target secondary node for conditional access by a user equipment;
determining, based at least in part on the received secondary radio link failure information, assistance information, wherein the assistance information assists the at least one target secondary node in determining which at least one of the plurality of suggested target primary cells of a secondary cell group is to be prepared by the at least one target secondary node for conditional access by a user equipment; and
transmitting, directly or indirectly, information indicative of the plurality of suggested target primary cells of a secondary cell group and the determined assistance information to the at least one target secondary node.

In some examples, the assistance information comprises priority information for the plurality of suggested target primary cells of a secondary cell group for preparation by the at least one target secondary node for conditional access by a user equipment.

In some examples, the assistance information comprises information indicative of a number of times that the suggested target primary cells of a secondary cell group were the correct choice for conditional access by a user equipment.

In some examples, transmitting information indicative of the plurality of suggested target primary cells of a secondary cell group and the determined assistance information comprises transmitting at least one SgNB Change Required message and/or at least one SgNB Addition Request message.

In some examples, the information indicative of the plurality of suggested target primary cells of a secondary cell group comprises at least one cell identity.

In some examples, the means comprises
at least one processor; and
at least one memory storing instructions that, when executed by the at least one processor, cause performance of the apparatus.

According to various, but not necessarily all, embodiments there is provided a method comprising:
receiving secondary radio link failure information, wherein the secondary radio link failure information is indicative of circumstances of a failure in a secondary radio link between a user equipment and at least one source secondary node while the user equipment was configured to conditionally access at least one target secondary node, and the user equipment is having dual connectivity with a source master node and a source secondary node;
determining a plurality of suggested target primary cells of a secondary cell group to be prepared by the at least one target secondary node for conditional access by a user equipment;
determining, based at least in part on the received secondary radio link failure information, assistance information, wherein the assistance information assists the at least one target secondary node in determining which at least one of the plurality of suggested target primary cells of a secondary cell group is to be prepared by the at least one target secondary node for conditional access by a user equipment; and
transmitting, directly or indirectly, information indicative of the plurality of suggested target primary cells of a secondary cell group and the determined assistance information to the at least one target secondary node.

In some examples, the assistance information comprises priority information for the plurality of suggested target primary cells of a secondary cell group for preparation by the at least one target secondary node for conditional access by a user equipment.

In some examples, the assistance information comprises information indicative of a number of times that the suggested target primary cells of a secondary cell group were the correct choice for conditional access by a user equipment.

In some examples, transmitting information indicative of the plurality of suggested target primary cells of a secondary cell group and the determined assistance information comprises transmitting at least one SgNB change required message and/or at least one SgNB Addition Request message.

In some examples, the information indicative of the plurality of suggested target primary cells of a secondary cell group comprises at least one cell identity.

According to various, but not necessarily all, embodiments there is provided a computer program comprising instructions for causing an apparatus to perform at least the following:
receiving secondary radio link failure information, wherein the secondary radio link failure information is indicative of circumstances of a failure in a secondary radio link between a user equipment and at least one source secondary node while the user equipment was configured to conditionally access at least one target secondary node, and the user equipment is having dual connectivity with a source master node and a source secondary node;
determining a plurality of suggested target primary cells of a secondary cell group to be prepared by the at least one target secondary node for conditional access by a user equipment;
determining, based at least in part on the received secondary radio link failure information, assistance information, wherein the assistance information assists the at least one target secondary node in determining which at least one of the plurality of suggested target primary cells of a secondary cell group is to be prepared by the at least one target secondary node for conditional access by a user equipment; and
transmitting, directly or indirectly, information indicative of the plurality of suggested target primary cells of a secondary cell group and the determined assistance information to the at least one target secondary node.

In some examples, the assistance information comprises priority information for the plurality of suggested target primary cells of a secondary cell group for preparation by the at least one target secondary node for conditional access by a user equipment.

In some examples, the assistance information comprises information indicative of a number of times that the suggested target primary cells of a secondary cell group were the correct choice for conditional access by a user equipment.

In some examples, transmitting information indicative of the plurality of suggested target primary cells of a secondary cell group and the determined assistance information comprises transmitting at least one SgNB change required message and/or at least one SgNB Addition Request message.

In some examples, the information indicative of the plurality of suggested target primary cells of a secondary cell group comprises at least one cell identity.

According to various, but not necessarily all, embodiments there is provided an apparatus comprising means for:
receiving information indicative of a plurality of suggested target primary cells of a secondary cell group to be prepared by a target secondary node for conditional access by a user equipment and assistance information configured to assist the target secondary node in determining which at least one of the plurality of suggested target primary cells of a secondary cell group is to be prepared by the at least one target secondary node for conditional access by a user equipment, wherein the assistance information is determined based at least in part on secondary radio link failure information associated with the target secondary node; and
determining based, at least in part, on the received assistance information, at least one of the plurality of suggested target primary cells of a secondary cell group to be prepared for conditional access by a user equipment; and
transmitting, to a master node, conditional access configuration information indicative of the determined at least one target primary cell of a secondary cell group.

In some examples, the assistance information comprises priority information for the plurality of suggested target primary cells of a secondary cell group for preparation by the at least one target secondary node for conditional access by a user equipment.

In some examples, the assistance information comprises information indicative of a number of times that the suggested target primary cells of a secondary cell group were the correct choice for conditional access by a user equipment.

In some examples, receiving the information indicative of the plurality of suggested target primary cells of a secondary cell group and the assistance information comprises receiving at least one SgNB Addition Request message.

In some examples, the assistance information is originated by a source master node or a source secondary node.

According to various, but not necessarily all, embodiments there is provided a method comprising:
receiving information indicative of a plurality of suggested target primary cells of a secondary cell group to be prepared by a target secondary node for conditional access by a user equipment and assistance information configured to assist the target secondary node in determining which at least one of the plurality of suggested target primary cells of a secondary cell group is to be prepared by the at least one target secondary node for conditional access by a user equipment, wherein the assistance information is determined based at least in part on secondary radio link failure information associated with the target secondary node; and
determining based, at least in part, on the received assistance information, at least one of the plurality of suggested target primary cells of a secondary cell group to be prepared for conditional access by a user equipment; and
transmitting, to a master node, conditional access configuration information indicative of the determined at least one target primary cell of a secondary cell group.

In some examples, the assistance information comprises priority information for the plurality of suggested target primary cells of a secondary cell group for preparation by the at least one target secondary node for conditional access by a user equipment.

In some examples, the assistance information comprises information indicative of a number of times that the suggested target primary cells of a secondary cell group were the correct choice for conditional access by a user equipment.

In some examples, receiving the information indicative of the plurality of suggested target primary cells of a secondary cell group and the assistance information comprises receiving at least one SgNB Addition Request message.

In some examples, the assistance information is originated by a source master node or a source secondary node.

According to various, but not necessarily all, embodiments there is provided a computer program comprising instructions for causing an apparatus to perform at least the following:
receiving information indicative of a plurality of suggested target primary cells of a secondary cell group to be prepared by a target secondary node for conditional access by a user equipment and assistance information configured to assist the target secondary node in determining which at least one of the plurality of suggested target primary cells of a secondary cell group is to be prepared by the at least one target secondary node for conditional access by a user equipment, wherein the assistance information is determined based at least in part on secondary radio link failure information associated with the target secondary node; and
determining based, at least in part, on the received assistance information, at least one of the plurality of suggested target primary cells of a secondary cell group to be prepared for conditional access by a user equipment; and
transmitting, to a master node, conditional access configuration information indicative of the determined at least one target primary cell of a secondary cell group.

In some examples, the assistance information comprises priority information for the plurality of suggested target primary cells of a secondary cell group for preparation by the at least one target secondary node for conditional access by a user equipment.

In some examples, the assistance information comprises information indicative of a number of times that the suggested target primary cells of a secondary cell group were the correct choice for conditional access by a user equipment.

In some examples, receiving the information indicative of the plurality of suggested target primary cells of a secondary cell group and the assistance information comprises receiving at least one SgNB Addition Request message.

In some examples, the assistance information is originated by a source master node or a source secondary node.

According to various, but not necessarily all, embodiments there is provided an apparatus comprising;
at least one processor; and
at least one memory storing instructions that, when executed by the at least one processor, cause an apparatus at least to perform at least a part of one or more methods disclosed herein.

According to various, but not necessarily all, embodiments there is provided an apparatus comprising means for performing at least part of one or more methods disclosed herein.

According to various examples, but not necessarily all examples, there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

The description of a function should additionally be considered to also disclose any means suitable for performing that function.

### BRIEF DESCRIPTION

Some examples will now be described with reference to the accompanying drawings in which:

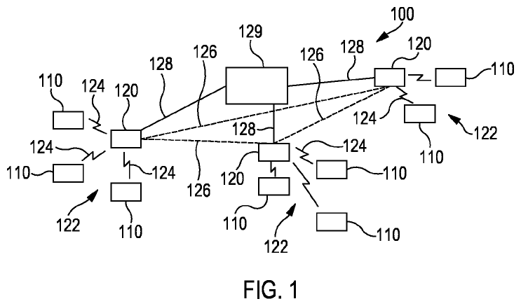

FIG. 1 shows an example of the subject matter described herein;

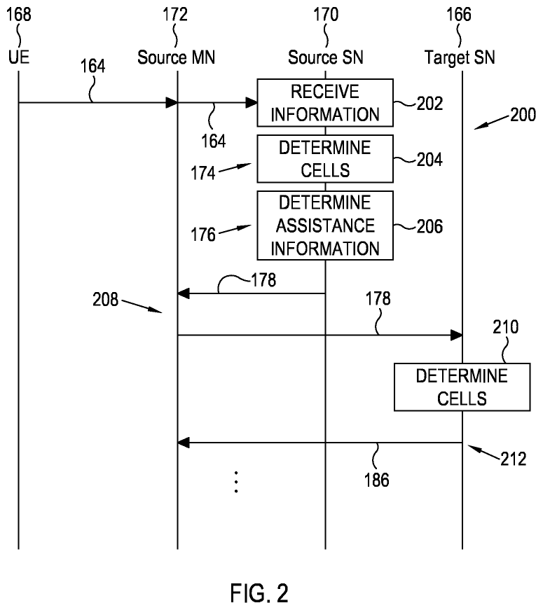

FIG. 2 shows another example of the subject matter described herein;

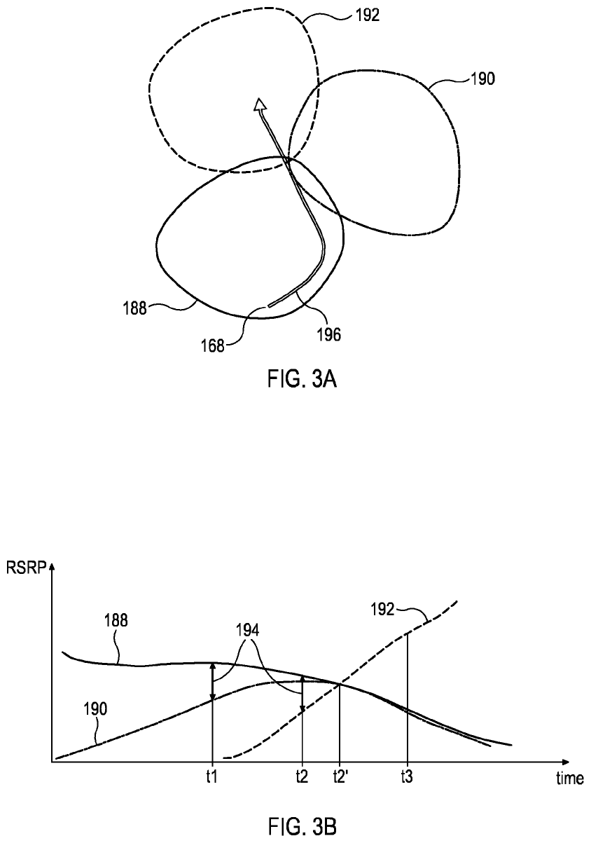

FIG. 3A shows another example of the subject matter described herein;

FIG. 3B shows another example of the subject matter described herein;

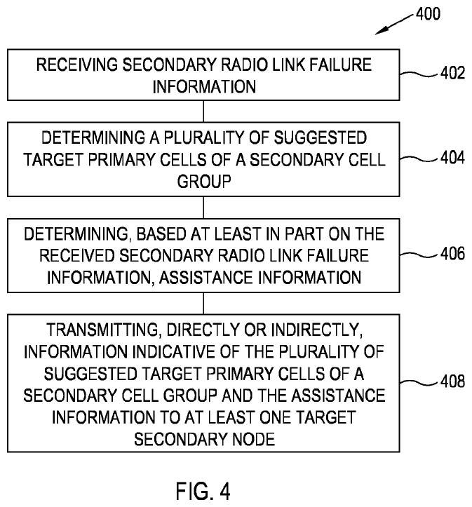

FIG. 4 shows another example of the subject matter described herein;

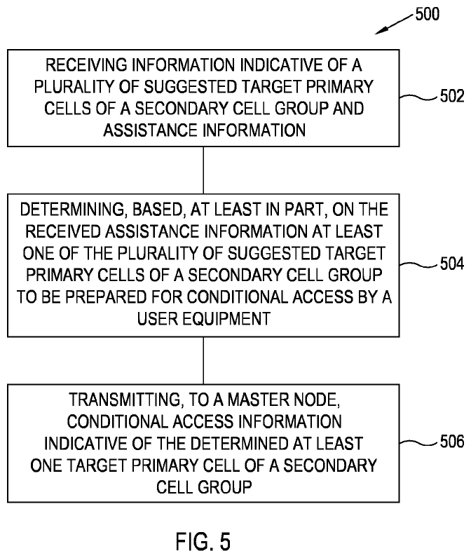

FIG. 5 shows another example of the subject matter described herein;

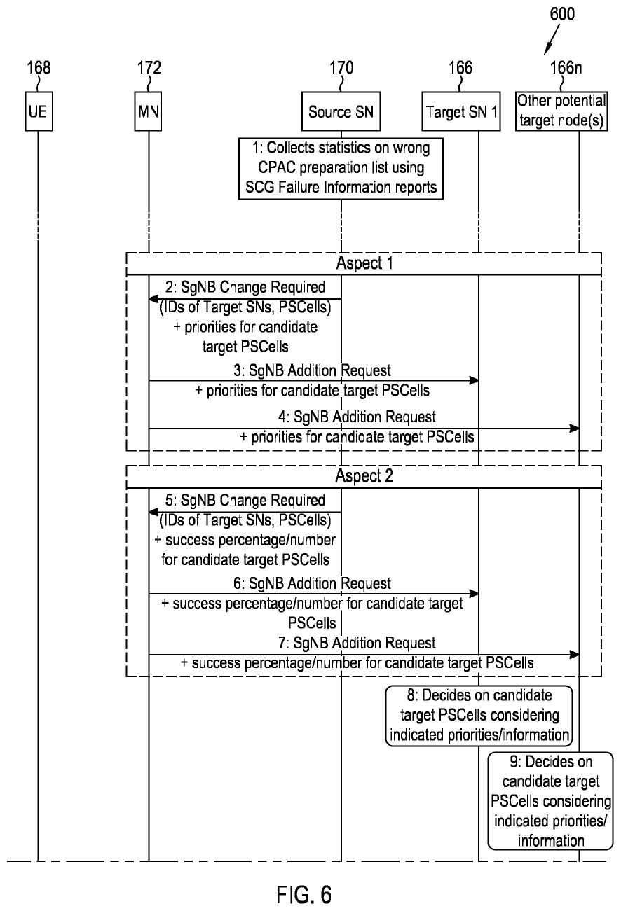

FIG. 6 shows another example of the subject matter described herein;

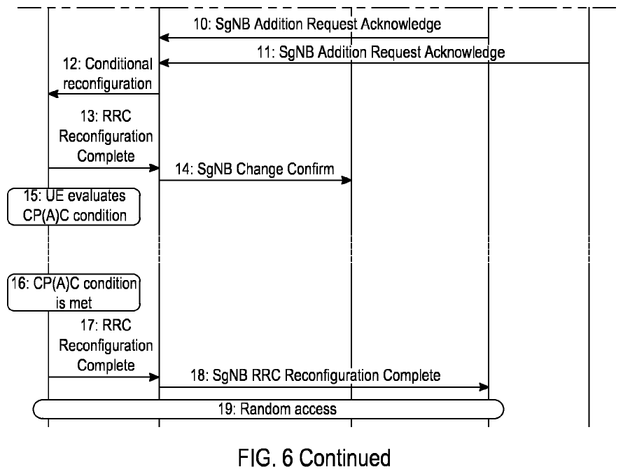

FIG. 7A shows another example of the subject matter described herein; and

FIG. 7B shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DEFINITIONS

Master Node (MN): Network node that provides control plane connectivity towards the core network.
Master Cell Group (MCG): Group of cells associated with the MN, includes PCell and SCell(s).
Secondary Node (SN): Network node that is providing additional radio resources for the UE but is not the MN.
Secondary Cell Group (SCG): Group of cells associated with the SN, includes PSCell and SCell(s).
PCell: The cell for uplink/downlink connection to MN. Cell of MCG used to initiate initial access to the MN.
PSCell: the cell for uplink/downlink connection to SN. Cell of SCG used to initiate initial access to the SN.
Conditional Handover (CHO)—a handover procedure that is triggered by the UE only when the configured execution condition(s) are met for a prepared candidate cell. Condition(s) are pre-configured by network. In 3GPP, a conditional handover execution condition is specified by condExecutionCond within the CondReconfig ToAddModList information element within the ConditionalReconfiguration information element within an RRCReconfiguration message.
Dual Connectivity (DC):
   UE has contemporaneous connection to an MN and an SN. This is a mode of operation of a UE in RRC_CONNECTED, configured with a Master Cell Group and a Secondary Cell Group.
Configuration Information:
   Information used to configure operation of a UE. In 3GPP, the configuration information can, for example, be provided in an RRCReconfiguration message.
   The term “configuration information comprising” an entity (for example handover execution condition for a primary cell; SN addition condition for dual connectivity with the primary cell and so on) can mean that the configuration information comprises information sufficient to obtain the entity. It may or may not comprise all parameters of the entity, it may instead comprise pointer to the entity or parameters of the entity or can mean that configuration includes the entity.
   In 3GPP, a RRCReconfiguration message specifies a ConditionalReconfiguration information element which provides addition conditions for the DC. The ConditionalReconfiguration information element comprises a CondReconfig ToAddModList information element. The CondReconfig ToAddModList information element comprises condExecutionCond and condRRCReconfig. Addition condition(s) for a primary secondary cell (PSCell) are specified by condExecutionCond. The RRCReconfiguration message to be applied when the specified conditions are met is provided by condRRCReconfig.
Measurement Configuration
   Configuration information used to configure a UE to perform measurement(s). In 3GPP, the measurement configuration can, for example, be provided in an RRCReconfiguration message. The term “[entity] measurement configuration” (for example source primary cell measurement configuration) can mean a measurement configuration prepared by the entity.
   Can comprise one or more measurement objects and one or more reporting configurations associated by one or more measurement identities.
   Can comprise a MeasConfig information element as defined in TS 38.331.

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a CELL 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In examples the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other examples the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an Xn interface 126. The gNBs are also connected by means of the N2 interface 128 to the Access and Mobility management Function (AMF).

In examples, the network 100 can comprise a combination of E-UTRAN and NG-RAN.

A user equipment can comprise a mobile equipment. Where reference is made to user equipment that reference includes and encompasses, wherever possible, a reference to mobile equipment.

A UE 168 can perform a handover procedure to change the serving cell of the UE 168. In examples, a handover procedure can be a conditional handover procedure.

A conditional handover (CHO) procedure can be considered a handover that is triggered by the UE 168 when one or more handover execution conditions are met. The handover execution condition or conditions can be pre-configured by the network 100.

In examples, a UE 168 can be provided with additional radio resources using dual connectivity (DC).

In DC, the configured set of serving cells for a UE 168 has two subsets: the Master Cell Group (MCG) containing the serving cells of a Master Node (MN) 172, and the Secondary Cell Group (SCG) containing the serving cells of a Secondary Node (SN) 170.

In examples, a conditional change of primary cell of a secondary cell group (PSCell) can be configured. A UE 168 can be configured with execution condition(s) for performing an SN change to one or more target SN 166. Accordingly, a UE 168 can be configured to conditionally access one or more target SN 166.

In examples, at least one target SN 166 can be configured to effectively and/or intelligently prepare, and can effectively and/or intelligently prepare, at least one target PSCell for conditional access by a UE 168.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other FIGs.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110, and three access nodes 120 transmit and/or receive one or more signals and/or one or more messages. In the example of FIG. 2 the terminal node 110 is a UE 168 and the three access nodes 120 are a source MN 172, a Source SN 172, and a target SN 166.

In the example of FIG. 2, the UE 168 has dual connectivity with the source MN 172 and source SN 170.

In examples, communications and/or transmissions between elements illustrated in FIG. 2 can proceed via any number of intervening elements, including no intervening elements.

Although one UE 168 is illustrated in the example of FIG. 2, in examples any suitable number of UEs 168 can be included.

Similarly, in examples, any suitable number of network nodes can be included.

In examples, method 200 and/or at least part of method 200 can be considered a method of enhancing conditional access of a target SN.

In examples, method 200 and/or at least part of method 200 can be considered a method of enhancing selection of at least one target PSCell for conditional access by a UE.

In examples, method 200 and/or at least part of method 200 can be considered a method of providing assistance information to a target SN to assist in selection of at least one target PSCell for conditional access by a UE.

In the illustrated example, the location of the blocks indicates the entity performing the action(s). For example, block 202 is performed at/by the source SN 170.

In examples, method 200 is part of a method to configure, and/or allow, and/or enable a UE 168 to conditionally access at least one target SN 166. In some examples, method 200 is part of a conditional PSCell addition and Change (CPAC) method/process/procedure. For example, method 200 can be part of a conditional PSCell Change (CPC) method/process/procedure or a conditional PSCell Addition (CPA) method/process.

In some examples, method 200 can be considered to be SN initiated. That is, in some examples, method 200 can be initiated by a source SN 170. For example, method 200 can be part of an SN initiated CPAC method/process/procedure.

In the illustrated example, method 200 is SN initiated and blocks 202, 204, and 206 are performed at/by the source SN 170, and block 208 involves the source SN 170.

In some examples, method 200 can be considered to be MN initiated. That is, in some examples, method 200 can be initiated by a source MN 172. For example, method 200 can be part of an MN initiated CPAC method/process/procedure.

In such examples, blocks 202, 204, and 206 are performed at/by the source MN 172, and block 208 is performed at/by the source MN 172.

At block 202, method 200 comprises receiving secondary link failure (S-RLF) information 164, wherein the S-RLF information is indicative of circumstances of a failure in a secondary radio link between a UE 168 and at least one source SN 170 while the UE 168 was configured to conditionally access at least one target SN 166, and the UE 168 is having dual connectivity with a source MN 172 and a source SN 170.

In some examples, method 200 comprises receiving secondary link failure (S-RLF) information 164 associated with at least one target secondary node 166, wherein the S-RLF information is indicative of circumstances of a failure in a secondary radio link between a UE 168 and at least one source SN 170 while the UE 168 was configured to conditionally access the at least one target SN 166, and the UE 168 is having dual connectivity with a source MN 172 and a source SN 170.

As FIG. 2 illustrates one or more actions of receiving, for example, of one or more signals, FIG. 2 also illustrates the corresponding transmitting/causing transmission feature(s)/action(s).

Similarly, for any transmitting/causing transmission feature(s)/action(s), FIG. 2 also illustrates the corresponding receiving/causing receiving feature(s)/action(s).

For example, from the point of view of the UE 168, block 202 can be considered to illustrate transmitting S-RLF information 164.

In some examples, S-RLF information 164 can be considered secondary cell group (SCG) failure information.

Receiving S-RLF failure information 164 can be performed in any suitable way, using any suitable method. In examples, receiving S-RLF information 164 comprises receiving one or more signals and/or messages.

In examples, the S-RLF information 164 can be received from any suitable number of different UEs 168. Accordingly, in examples, the S-RLF information 164 is indicative of circumstances of failures in a secondary radio link experienced by a plurality of different UEs.

In some examples, at block 202, method 200 comprises receiving secondary link failure (S-RLF) information 164, wherein the S-RLF information is indicative of circumstances of a failure in a secondary radio link between a plurality of UEs 168 and at least one source SN 170 while the UEs 168 were configured to conditionally access at least one target SN 170, and the UEs 168 having dual connectivity with a source MN 172 and a source SN 170.

The S-RLF information 164 can be received, and/or collected, over any suitable time period. For example, the S-RLF information 164 can be received from a plurality of UEs 168 over a time period long enough to allow sufficient S-RLF information 164 to be received to allow method 200 to be performed. For example, the S-RLF information 164 can be received over a time period long enough to allow sufficient S-RLF information 164 to be received to allow assistance information 176 to be determined at block 206.

In examples, the time period can be 2 to 3 hours, half a day, a day, 2 to 3 days, a week, 2 to 3 weeks, a month and so on.

In examples, the S-RLF information 164 can be received over a Key Performance Indicator (KPI) collection period.

S-RLF information 164 can comprise any suitable information. For example, S-RLF information 164 can comprise any suitable information indicative of circumstances of a failure in a secondary radio link between a UE 168 at least one source SN 170 while the UE 168 was configured to conditionally access at least one target SN 166, and the UE 168 having dual connectivity with a source MN 172 and a source SN 170.

For example, S-RLF information 164 can comprise any suitable information to allow assistance information 176 to be determined at block 206.

In examples, S-RLF information 164 comprises SCG failure report information transmitted by a UE 168 when the UE 168 detects a radio link failure for the connection with the PSCell of a source SN 170.

S-RLF information 164 can comprise failure type (for example due to downlink or uplink radio problem), and/or location information of the UE 168, and/or received signal power information, and/or time information, and/or information regarding configuration of the UE 168 and so on.

In the example of FIG. 2, the method 200 is SN initiated and the S-RLF information 164 is transmitted from the UE 168 to the source MN 172, and forwarded by the source MN 172 to the source SN 170.

However, in MN initiated examples, the S-RLF information 164 can be transmitted from the UE 168 to the source MN 172 without forwarding of the S-RLF information 164 to the source SN 170, and block 202 is performed at/by the source MN 172.

In examples, the S-RLF information 164 is associated with at least one target SN 166 and is indicative of circumstances of a failure in a secondary radio link between a UE 168 and at least one source secondary node 170 while the UE 168 was configured to conditionally access the at least one target SN 166.

S-RLF information 164 can be considered to be associated with a target SN 166 because the S-RLF information 164 resulted from a secondary radio link failure occurring while a UE 168 was configured to conditionally access the target SN 166.

Circumstances of a failure in a secondary radio link can be considered conditions of a failure in a secondary radio link.

Circumstances of a failure in a secondary radio link can be considered to be a setting, and/or situation of a failure in a secondary radio link.

Circumstances of a failure in a secondary radio link can be considered physical circumstances, and/or radio circumstances that the UE 168 experienced for a period of time prior to the S-RLF.

Any suitable period of time can be used. For example, any suitable period of time that adequately covers the circumstances of an S-RLF can be used.

For example, a period of time in the range 5 seconds to 30 minutes can be used.

For example, a period of time in the range 30 seconds to 20 minutes can be used.

For example, a period of time in the range 1 minute to 15 minutes can be used.

For example, a period of time in the range 5 minutes to 10 minutes can be used.

In examples, the period of time can be at least M seconds, wherein M is a positive integer.

In examples, the period of time can be at least X minutes, wherein X is a positive integer.

By way of example, REFERENCE IS MADE to the EXAMPLE of FIG. 3A.

FIG. 3A illustrates an example scenario. In the example of FIG. 3 a UE 168 is located within and is being served by a source PSCell 188.

In the illustrated example, the UE 168 moves along the trajectory 196 and as the UE 168 moves along the trajectory 196 the UE detects two PSCells, PSCell1 190 and PSCell2 192.

FIG. 3B illustrates a plot of reference signal received power (RSRP) for the source PSCell 188, PSCell1 190, and PSCell2 192 as the UE 168 moves along the trajectory 196 shown in the example of FIG. 3A.

With regard to the plot shown in the example of FIG. 3B, at time t1 PSCell1 190 reaches a measurable signal strength that fulfills the RSRP offset 194 configured at the UE 168 and triggers a preparation of PSCell 1 190 as candidate cell for conditional access by the UE 168, such as CPC.

At time t2 PSCell2 192 also fulfils the RSRP offset 194 preparation criterion configured at the UE 168 and a measurement event report is sent from the UE 168 to the source PSCell 188, which in turn triggers, for example, a SgNB (Conditional) Change Required message to MN and, for example, a SgNB (Conditional) Addition Request message from MN to target SN including measurement results of the target PSCell1 190 and PSCell2 192.

In the illustrated example, the target SN may decide on the preparation of target PSCell1 190, as target PSCell1 190 has the best received measurement.

However, later on in the example of FIG. 3B, at time instance t3, the UE 168 experiences a secondary radio link failure on the currently serving PSCell and sends S-RLF Failure Information to MN.

In the illustrated example, the target SN misses the preparation of target PSCell2 192 which results in an S-RLF in the source PSCell 188, because the conditional access execution criterion for the prepared PSCell1 190 was not reached.

FIG. 3A and FIG. 3B can be considered to illustrate the circumstances of the S-RLF experienced by the UE 168. In the example of FIG. 3 the S-RLF information 164 comprises information indicative of the circumstances, for example the UE trajectory 196, and/or RSRP measurements, and/or timing, and/or UE configuration and so on.

In the example of FIGS. 3A and 3B, the information included in the S-RLF information 164 may show that target PSCell2 192 should have been prepared in this case (as it has the best measurements when the S-RLF occurred).

However, in this example, the target SN 166 decided about the cell(s) to be prepared as candidates for conditional access by a UE 196, for example candidates for CPAC, based on the information available at the time. Furthermore, the number of cells that can be prepared may be limited.

Returning to the example of FIG. 2, in examples, the S-RLF information 164 is indicative of circumstances of a failure in a secondary radio link between a UE 168 and at least one source secondary node 170 while the UE 168 was configured to conditionally access at least one target SN 166.

The UE 168 can be configured to conditionally access the at least one target SN 166 in any suitable way, using any suitable method. For example, the UE 168 can receive any suitable configuration information to configure the UE 168 to access the at least one target SN 166 upon fulfillment of at least one criterion.

In examples, the UE 168 is configured with at least one CPAC configuration. For example, the UE 168 can be configured with at least one CPC or CPA configuration.

In examples, accessing a PSCell, or any other suitable cell, comprises performing a random access procedure with the cell.

In examples, accessing a PSCell, or any other suitable cell, comprises establishing a connection with the cell.

In examples, the source SN 170, or source MN 172 in MN initiated examples, can determine statistics based, at least in part, on the received S-RLF information 164. For example, the source SN 170, or source MN 172 in MN initiated examples, can determine statistics based on a significant amount of wrong target PSCell preparations observed via S-RLF information 164, see, for example, FIGS. 3A and 3B.

In examples, this can be done until statistical convergence is achieved.

At block 204, method 200 comprises determining a plurality of suggested target PSCells 174 to be prepared by the at least one target secondary node 166 for conditional access by a UE 168.

Determining a plurality of suggested target PSCells 174 to be prepared by the at least one target SN 166 can be performed in any suitable way using any suitable method. For example, determining a plurality of suggested target PSCells 174 at block 204 can be performed as part of a CPAC method/process/procedure, for example as part of a CPC method/process/procedure or CPA method/process/procedure.

In examples, the target SN 166 cannot prepare PSCells for conditional access by a UE 168 that are not included in the suggested target PSCells 174.

In examples, the source SN 170, or in MN initiated examples the source MN 172, can determine that a change in PSCell may be needed for the UE 168 and perform block 206 based, at least in part, on that determination. For example, the source SN 170 (or source MN 172) can receive at least one measurement report from the UE 168 and determine that a change in PSCell may be needed for the UE 168 based, at least in part, on the received at least one measurement report.

The UE 168 can be a UE 168 from which S-RLF information 164 has been received or can be a UE 168 from which S-RLF information 164 has not been received.

In some examples, the source SN 170 (or source MN 172) determines conditional access execution condition(s) for each of the plurality of suggested target PSCells 174. For example, the source SN 170 (or source MN 172) can determine CPAC execution conditions, for example CPC or CPA execution conditions, for each of the plurality of suggested target PSCells 174.

In some examples, the source SN 170 (or source MN) determines a maximum amount of target PSCells that can be prepared by the target SN 166. Accordingly, in examples, the target SN is to prepare a limited number of target PSCells from the plurality of suggested target PSCells 174.

At block 206, method 200 comprises determining, based at least in part on the received S-RLF information 164, assistance information 176, wherein the assistance information is configured to assist and/or assists the at least one target SN 166 in determining which of the plurality of suggested target PSCells 174 is to be prepared by the at least one target SN 166 for conditional access by a UE 168.

Block 206 can be performed in any suitable way using any suitable method. In examples, received S-RLF information 164 can be used in any suitable way to determine assistance information 176.

For example, S-RLF information 164 can be processed and/or analyzed in any suitable way to allow assistance information 176 to be determined. For example, statistics determined from the S-RLF information 164 can be used in determining assistance information 174.

Accordingly, in examples, determining, based at least in part on the received S-RLF information 164, assistance information 176 comprises determining, based at least in part on analysis of and/or statistics determined from the received S-RLF information 164, assistance information 176.

For example, with regard to the example of FIG. 3, the determined assistance information 176 is configured to assist a UE 168 to prepare candidate PSCell2 192 for conditional access by a UE 168, instead of candidate PSCell1 190.

In some examples, determining assistance information comprises using a mobility robustness optimization algorithm, and/or artificial intelligence, and/or machine learning technique(s).

Assistance information 176 can comprise any suitable information having any suitable form. For example, assistance information 176 can comprise any suitable information to assist at least one target SN 166 in determining which at least one of a plurality of suggested target PSCells 174 is to be prepared by the at least one target SN 166 for conditional access by a UE 168.

In examples, assistance information 176 can comprise any suitable information to indicate to a target SN that at least one of the plurality of suggested target PSCells 174 is to be preferentially prepared compared to at least one other of the plurality of suggested target PSCells 174.

In examples, assistance information can comprise any suitable information to indicate a ranking of the plurality of suggested target PSCells 174 for preparation by the at least one target SN 166 for conditional access by a UE 168.

In some examples, the assistance information 176 comprises priority information for the plurality of suggested target PSCells 174 for preparation by the at least one target SN 166 for conditional access by a UE 168.

Priority information can be considered information to indicate to a target SN 166 to prioritize the preparation of at least one specific suggested target PSCell 174 over at least one other suggested target PSCell 174 of the plurality of suggested target PSCells 174.

For example, priority information can indicate to the target SN 166 in the example of FIG. 3 to prioritize preparation of target PSCell2 192 over target PSCell1 190 for conditional access by a UE 168.

Priority information can comprise any suitable information having any suitable form. For example, priority information can comprise any suitable information to indicate to a target SN 166 to prioritize preparation of at least one specific suggested target PSCell 174 over at least one other suggested target PSCell 174 of the plurality of suggested target PSCells 174.

In examples, priority information can comprise a value, associated with each of the plurality of suggested target PSCells 174, indicating the priority of the associated target PSCell. For example, priority information can comprise a value between 0 and 100 for the plurality of suggested PSCells 174 where, for example, 0 indicates the lowest priority and 100 indicates the highest priority.

In some examples, the assistance information 176 comprises information indicative of a number of times that the suggested target PSCells 174 were the correct choice for conditional access by a UE 168.

In examples, information indicative of a number of times that the suggested target PSCells 174 were the correct choice for conditional access by a UE 168 can comprise any suitable information having any suitable form. For example, the information indicative of a number of times that the suggested target PSCells 174 were the correct choice for conditional access by a UE 168 can indicate the number of times in absolute or relative terms.

For example, the information can indicate a number of times that each of the plurality of suggested target PSCells 174 were the correct choice and/or can indicate a percentage of times that each of the plurality of suggested target PSCells 174 were the correct choice.

A target PSCell can be considered a correct choice for conditional access by a UE 168 if, under the circumstances of an S-RLF, conditional access of the target PSCell by a UE 168 would have prevented the S-RLF.

For example, in the example of FIG. 3, PSCell2 192 can be considered the correct choice for conditional access by a UE 168 because, under the circumstances of the S-RLF failure in the example of FIG. 3, the S-RLF would have been prevented if the UE 168 was configured to conditionally access PSCell 2 192.

At block 208, method 200 comprises transmitting, directly or indirectly, information 178 indicative of the plurality of suggested PSCells 174 and the determined assistance information 176 to the at least one target SN 166.

Consequently, FIG. 2 illustrates a method 200 comprising:
receiving secondary radio link failure information 164, wherein the secondary radio link failure information 164 is indicative of circumstances of a failure in a secondary radio link between a user equipment 168 and at least one source secondary node 172 while the user equipment 168 was configured to conditionally access at least one target secondary node 166, and the user equipment 168 is having dual connectivity with a source master node 172 and a source secondary node 170;
determining a plurality of suggested target primary cells of a secondary cell group 174 to be prepared by the at least one target secondary node for conditional access by a user equipment 168;
determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168; and
transmitting, directly or indirectly, information 178 indicative of the plurality of suggested target primary cells of a secondary cell group 174 and the determined assistance information 176 to the at least one target secondary node 166.

Information 178 indicative of the plurality of suggested PSCells 174 and the determined assistance information 176 can comprise any suitable information.

In some examples, the information 178 indicative of the plurality of suggested target PSCells 174 comprises at least one cell identity, for example at least one physical cell identity (PCI), and/or at least one global cell identity and so on.

Block 208 can be performed in any suitable way using any suitable method. In examples, transmitting information 178 at block 208 comprises transmitting at least one signal and/or message.

In some SN-initiated examples, the information 178 at block 208 is transmitted from the source SN 170 to the source MN 172 and forwarded by the source MN 172 to the at least one target SN 166.

In some MN-initiated examples, the information 178 at block 208 is transmitted from the source MN 172 to the at least one target SN 166.

In some examples, transmitting information 178 indicative of the plurality of suggested target PSCells 174 and the determined assistance information 176 comprises transmitting at least one SgNB Change Required message and/or at least one SgNB Addition Request message.

In examples, from the point of view of the target SN 166, block 208 comprises receiving information 178 indicative of a plurality of suggested target PSCells 174 to be prepared by a target SN 166 for conditional access by a UE 168 and assistance information 176 configured to assist the target SN 166 in determining which at least one of the plurality of suggested target PSCells is to be prepared by the at least one target SN 166 for conditional access by a UE 168, wherein the assistance information 176 is determined based, at least in part, on S-RLF information 164 associated with the target SN 166.

In examples, from the point of view of the target SN 166, receiving the information 178 indicative of the plurality of suggested target PSCells 174 and the assistance information 176 comprises receiving at least one SgNB Addition Request message.

In examples, the assistance information 176 is originated by a source MN 172 or a source SN 170.

At block 210, method 200 comprises determining, based, at least in part, on the received assistance information 176, at least one of the plurality of suggested target PSCells 174 to be prepared for conditional access by a UE 168.

Block 210 can be performed in any suitable way, using any suitable method.

In examples, the assistance information 176 can be used in any suitable way to assist the target SN 166 to determine which at least one of the plurality of suggested target PSCells 174 is to be prepared for conditional access by a UE 168.

In some examples, the assistance information 176 is used by the target SN 166 to determine which at least one of the plurality of suggested target PSCells 174 should preferentially be prepared for conditional access by a UE 168 compared to at least one other of the plurality of suggested target PSCells 174.

In examples, the target SN 166 can determine, based, at least in part, on the assistance information 176 which at least one of the plurality of suggested target PSCells 174 has the highest priority or priorities for preparation for conditional access by a UE 168.

For example, in at least some examples where the assistance information 176 comprises priority information, the target SN 166 can determine which at least one of the plurality of suggested target PSCells 174 has the highest associated priority value or values.

For example, in at least some examples where the assistance information comprises information indicative of a number of times that the suggested target PSCells 174 were the correct choice for conditional access by a UE 168, the target SN 166 can determine which at least one or ones of the plurality of suggested PSCells 174 has the highest associated number of times.

For example, with regard to the example of FIG. 3A, the assistance information 176 can include a priority value of 80 for PSCell 2 192 and a priority value of 20 for PSCell 1 190, assisting the target SN 166 to preferentially prepare PSCell2 192 for conditional access by a UE 168, avoiding the S-RLF.

In examples, the target SN 166 can prepare the determined at least one of the plurality of suggested target PSCells 174 for conditional access by a UE 168. The target SN 166 can prepare the determined at least one of the plurality of suggested target PSCells 174 for CPAC, for example for CPC or CPA.

In examples, the target SN 166 can prepare conditional access configuration information 186 for the determined at least one of the plurality of suggested target PSCells 174.

Conditional access configuration information 186 can comprise any suitable information. For example, conditional access configuration information 186 can comprise any suitable information to configure a UE 168 to access the determined at least one of the plurality of suggested target PSCells 174 upon fulfilment of at least one criterion.

In examples, the conditional access configuration information 186 can comprise CPAC configuration information. For example, the conditional access configuration information 186 can comprise CPA or CPC configuration information.

In some examples, the conditional access configuration information 186 comprises a CPAC configuration, such as a CPA or a CPC configuration, for each of the determined at least one of the plurality of suggested target PSCells 174.

At block 210, method 200 comprises transmitting, to a MN 172, conditional access configuration information 186 indicative of the determined at least one target PSCell. In examples, the determined at least one target PSCell is the at least one target PSCell determined in/at block 210.

Consequently, FIG. 2 illustrates a method 200 comprising:
receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure information 164 associated with the target secondary node 166; and
determining based, at least in part, on the received assistance information 176, at least one of the plurality of suggested target primary cells of a secondary cell group 174 to be prepared for conditional access by a user equipment 168; and
transmitting, to a master node 172, conditional access configuration information 186 indicative of the determined at least one target primary cell of a secondary cell group.

In examples, the conditional access configuration information 186 can be considered conditional access configuration information 186 of and/or for the determined at least one target PSCell.

Block 210 can be performed in any suitable way using any suitable method. In examples, transmitting, to a MN 172, conditional access configuration information 186 indicative of the determined at least one target PSCell comprises transmitting at least one signal and/or message.

In some examples, the target SN 166 transmits to the MN 172 an identifier, for example a cell identity, for example a physical cell identity (PCI), and/or a global cell identity and so on, of the prepared target PSCells(s).

In examples, method 200 can then proceed according to a conditional access method/process/procedure to configure the UE to conditionally access the target SN 165 based, at least in part, on the information transmitted at block 212.

For example, method 200 can then proceed according to a CPAC method/process/procedure, such as a CPA or CPC method/process/procedure. See, for example, FIG. 6.

In examples, method 200 can be repeated any suitable number of times.

As previously noted, examples can make use of mobility robustness optimization algorithm(s). In this regard, Self-Organizing Networks (SONs) are networks that are able to automatically adjust the radio network parameters based on the collected statistics from the network. Mobility Robustness Optimization (MRO) is an example of SON which, in examples, deals with the adjustment of the parameters controlling the cell change (for example the change of PSCell).

In MRO, the network collects, in examples, statistics for a certain period of time (failure report can be one of them), denoted by, for example, KPI collection period. In each KPI collection period, for example, the KPI statistics are processed by the network and decisions are taken to make changes. The network applies the changes, for example to assistance information, and collects new statistics with the changes in, for example, a new KPI collection period.

This process can be repeated by the network until it reaches a KPI collection period where it decides that nothing needs to be done (for example, the problem is solved or tuning the threshold/offset is no longer possible).

At this case, it can be considered that MRO has converged. In examples, the values of performance metrics, collected in each of KPI collection period, should be statistically significant (high number of statistics) to have reliable network decisions when making changes.

Examples of the disclosure are advantageous and provide technical benefits.

For example, examples of the disclosure allow a target SN to select the proper target PSCells among the suggested ones.

For example, examples of the disclosure reduce radio link failures caused by preparing the wrong candidate PSCells.

FIG. 4 illustrates an example of a method 400.

In examples, method 400 can be performed by any suitable apparatus comprising any suitable means for performing method 400. For example, an apparatus as described in relation to FIGS. 7A and/or 7B.

In examples, method 400 can be performed by a source SN 170, such as a source SN of FIG. 2.

In examples, method 400 can be performed by a source MN 172, such as a source MN of FIG. 2.

At block 402, method 400 comprises receiving secondary radio link failure information 164, wherein the secondary radio link failure information 164 is indicative of circumstances of a failure in a secondary radio link between a user equipment 168 and at least one source secondary node 170 while the user equipment 168 was configured to conditionally access at least one target secondary node 166, and the user equipment 168 is having dual connectivity with a source master node 172 and a source secondary node 170.

At block 404, method 400 comprises determining a plurality of suggested target primary cells of a secondary cell group 174 to be prepared by the at least one target secondary node 166 for conditional access by a user equipment 168.

At block 406, method 400 comprises determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168.

At block 408, method 400 comprises transmitting, directly or indirectly, information 178 indicative of the plurality of suggested target primary cells of a secondary cell group 174 and the determined assistance information 176 to the at least one target secondary node 166.

Consequently, FIG. 4 illustrates a method 400 comprising:
receiving secondary radio link failure information 164, wherein the secondary radio link failure information 164 is indicative of circumstances of a failure in a secondary radio link between a user equipment 168 and at least one source secondary node 170 while the user equipment 168 was configured to conditionally access at least one target secondary node 166, and the user equipment 168 is having dual connectivity with a source master node 172 and a source secondary node 170;
determining a plurality of suggested target primary cells of a secondary cell group 174 to be prepared by the at least one target secondary node 166 for conditional access by a user equipment 168;
determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168; and
transmitting, directly or indirectly, information 178 indicative of the plurality of suggested target primary cells of a secondary cell group 174 and the determined assistance information 176 to the at least one target secondary node 166.

FIG. 5 illustrates an example of a method 500.

In examples, method 500 can be performed by any suitable apparatus comprising any suitable means for performing method 500. For example, an apparatus as described in relation to FIGS. 7A and/or 7B.

In examples, method 500 can be performed by a target SN 166, such as a target SN 166 of FIG. 2.

At block 502, method 500 comprises receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure 164 information associated with the target secondary node 166.

At block 504, method 500 comprises determining based, at least in part, on the received assistance information 176, at least one of the plurality of suggested target primary cells of a secondary cell group 174 to be prepared for conditional access by a user equipment 168.

At block 506, method 500 comprises transmitting, to a master node 172, conditional access configuration information 186 indicative of the determined at least one target primary cell of a secondary cell group.

Consequently, FIG. 5 illustrates a method 500 comprising:
receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure 164 information associated with the target secondary node 166;
determining based, at least in part, on the received assistance information 176, at least one of the plurality of suggested target primary cells of a secondary cell group 174 to be prepared for conditional access by a user equipment 168; and
transmitting, to a master node 172, conditional access configuration information 186 indicative of the determined at least one target primary cell of a secondary cell group.

FIG. 6 illustrates an example of a method 600.

Some examples relate to third generation Partnership Project (3GPP) network. FIG. 6 can be considered to illustrate some such examples.

The following description can be considered to illustrate some such examples.

In the example of FIG. 6, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 6 form at least a portion of a network 100 as described in relation to FIG. 1.

In the illustrated example, a terminal node 110, and four or more access nodes 120 transmit and/or receive one or more signals and/or one or more messages. In the example of FIG. 6 the terminal node 110 is a UE 168 and the four or more access nodes 120 are a source MN 172, a Source SN 170, a target SN 166 and other potential target node(s) 166n.

In the example of FIG. 6, the UE 168 has dual connectivity with the source MN 172 and source SN 170.

In examples, communications and/or transmissions between elements illustrated in FIG. 6 can proceed via any number of intervening elements, including no intervening elements.

Although one UE 168 is illustrated in the example of FIG. 6, in examples any suitable number of UEs 168 can be included.

Similarly, in examples, any suitable number of network nodes can be included.

A high-level flow chart is shown in FIG. 6, where SN initiated CPC is made. However, in examples, MN initiated CPC can be made.
Block1: Source SN collects information/statistics on “wrong CPC preparation list” using SCG Failure Information reports received from the UEs and updates its priorities/information to be sent to other nodes in case of SN change.

### Aspect 1:

·Block 2: Source SN initiates an inter-SN PSCell change by indicating to the target SN to prioritize the preparation of specific target PSCell(s) over others with providing priorities for each suggested target PSCell.
·Block 3/4: MN forwards the received priorities to the target SN(s), along with the SgNB Addition Requests.

### Aspect 2: Note That This Aspect Can Be Implemented in Addition to or Independent From Aspect 1.

Block 5: Source SN initiates an inter-SN PSCell change by indicating to the target SN the information about the success possibility of being the right PSCell for each suggested target PSCell. This number can be an absolute number or a percentage.
Block 6/7: MN forwards the received information to the target SN(s), along with the SgNB Addition Requests.
Block 8/9: Target SN(s)/other potential target node(s) prioritises the target PSCells with high priority or high success possibility as indicated by the source SN, while selecting target PSCell(s) for CPC configuration.
In block 10/11, the target SN sends to MN the CPC configuration for each prepared target PSCell and the ID of the prepared target PSCell(s).
In block 12, the MN sends to the UE a conditional (re-)configuration containing the CPC configurations of the candidate target PSCell(s) along with the CPC execution conditions.
In block 13, the UE sends a message to MN confirming the reception of the conditional configuration and MN confirms in turn to source SN the SN change preparation in block 14.
In block 15, the UE evaluates the CPC execution conditions of the prepared target PSCell(s).
In block 16, the CPC execution condition is met for example a PSCell candidate in target SN 1.
The UE sends a message to MN in block 17 indicating the execution of the CPC configuration. The message includes an embedded SN RRC Reconfiguration Complete to the target SN 1 which is sent in block 18.
The UE completes the random access in block 19.

FIG. 7A illustrates an example of an apparatus 130. The apparatus 130 may be a controller of an apparatus of device such as a terminal node 110, for example a UE 168, or network element 172, 170, and/or 166, such as an eNB or gNB. The apparatus 130 may be considered a controller.

Implementation of a 130 may be as controller circuitry. The controller 130 may be implemented in hardware alone, have certain aspects in software including firmware alone or can be a combination of hardware and software (including firmware).

As illustrated in FIG. 7A the controller 130 may be implemented using instructions that enable hardware functionality, for example, by using executable instructions of a computer program 136 in a general-purpose or special-purpose processor 132 that may be stored on a computer readable storage medium (disk, memory etc) to be executed by such a processor 132.

The processor 132 is configured to read from and write to the memory 134. The processor 132 may also comprise an output interface via which data and/or commands are output by the processor 132 and an input interface via which data and/or commands are input to the processor 132.

The memory 134 stores a computer program 136 comprising computer program instructions (computer program code) that controls the operation of the apparatus 130 when loaded into the processor 132. The computer program instructions, of the computer program 136, provide the logic and routines that enables the apparatus to perform the methods illustrated in the accompanying Figs. The processor 132 by reading the memory 134 is able to load and execute the computer program 136.

In examples, the apparatus 130 comprises:
at least one processor 132; and
at least one memory 134 including computer program code
the at least one memory 134 and the computer program code configured to, with the at least one processor 132, cause the apparatus 130 at least to perform:
   receiving secondary radio link failure information 164, wherein the secondary radio link failure information 164 is indicative of circumstances of a failure in a secondary radio link between a user equipment 168 and at least one source secondary node 170 while the user equipment 168 was configured to conditionally access at least one target secondary node 166, and the user equipment 168 is having dual connectivity with a source master node 172 and a source secondary node 170;
   determining a plurality of suggested target primary cells of a secondary cell group 174 to be prepared by the at least one target secondary node 166 for conditional access by a user equipment 168;
   determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168; and
   transmitting, directly or indirectly, information 178 indicative of the plurality of suggested target primary cells of a secondary cell group 174 and the determined assistance information 176 to the at least one target secondary node 166.

In examples, the apparatus 130 comprises:
at least one processor 132; and
at least one memory 134 including computer program code
the at least one memory 134 and the computer program code configured to, with the at least one processor 132, cause the apparatus 130 at least to perform:
   receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure 164 information associated with the target secondary node 166;
   determining based, at least in part, on the received assistance information 176, at least one of the plurality of suggested target primary cells of a secondary cell group 174 to be prepared for conditional access by a user equipment 168; and
   transmitting, to a master node 172, conditional access configuration information 186 indicative of the determined at least one target primary cell of a secondary cell group.

In examples, the apparatus 130 comprises:
at least one processor 132; and
   at least one memory 134 including computer program code,
   the at least one memory storing instructions that, when executed by the at least one processor 132, cause the apparatus at least to:
      receiving secondary radio link failure information 164, wherein the secondary radio link failure information 164 is indicative of circumstances of a failure in a secondary radio link between a user equipment 168 and at least one source secondary node 170 while the user equipment 168 was configured to conditionally access at least one target secondary node 166, and the user equipment 168 is having dual connectivity with a source master node 172 and a source secondary node 170;
      determining a plurality of suggested target primary cells of a secondary cell group 174 to be prepared by the at least one target secondary node 166 for conditional access by a user equipment 168;
      determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168; and
      transmitting, directly or indirectly, information 178 indicative of the plurality of suggested target primary cells of a secondary cell group 174 and the determined assistance information 176 to the at least one target secondary node 166.

In examples, the apparatus 130 comprises:
at least one processor 132; and
   at least one memory 134 including computer program code,
   the at least one memory storing instructions that, when executed by the at least one processor 132, cause the apparatus at least to:
      receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure 164 information associated with the target secondary node 166;
      determining based, at least in part, on the received assistance information 176, at least one of the plurality of suggested target primary cells of a secondary cell group 174 to be prepared for conditional access by a user equipment 168; and
      transmitting, to a master node 172, conditional access configuration information 186 indicative of the determined at least one target primary cell of a secondary cell group.

As illustrated in FIG. 7A, the computer program 136 may arrive at the apparatus 130 via any suitable delivery mechanism 162. The delivery mechanism 162 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 136. The delivery mechanism may be a signal configured to reliably transfer the computer program 136. The apparatus 130 may propagate or transmit the computer program 136 as a computer data signal.

Computer program instructions for causing an apparatus to perform at least the following or for performing at least the following:
receiving secondary radio link failure information 164, wherein the secondary radio link failure information 164 is indicative of circumstances of a failure in a secondary radio link between a user equipment 168 and at least one source secondary node 170 while the user equipment 168 was configured to conditionally access at least one target secondary node 166, and the user equipment 168 is having dual connectivity with a source master node 172 and a source secondary node 170;
determining a plurality of suggested target primary cells of a secondary cell group 174 to be prepared by the at least one target secondary node 166 for conditional access by a user equipment 168;
determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168; and
transmitting, directly or indirectly, information 178 indicative of the plurality of suggested target primary cells of a secondary cell group 174 and the determined assistance information 176 to the at least one target secondary node 166.

Computer program instructions for causing an apparatus to perform at least the following or for performing at least the following:
receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure 164 information associated with the target secondary node 166;
determining based, at least in part, on the received assistance information 176, at least one of the plurality of suggested target primary cells of a secondary cell group 174 to be prepared for conditional access by a user equipment 168; and
transmitting, to a master node 172, conditional access configuration information 186 indicative of the determined at least one target primary cell of a secondary cell group.

The computer program instructions may be comprised in a computer program, a non-transitory computer readable medium, a computer program product, a machine readable medium. In some but not necessarily all examples, the computer program instructions may be distributed over more than one computer program.

Although the memory 134 is illustrated as a single component/circuitry it may be implemented as one or more separate components/circuitry some or all of which may be integrated/removable and/or may provide permanent/semi-permanent/dynamic/cached storage.

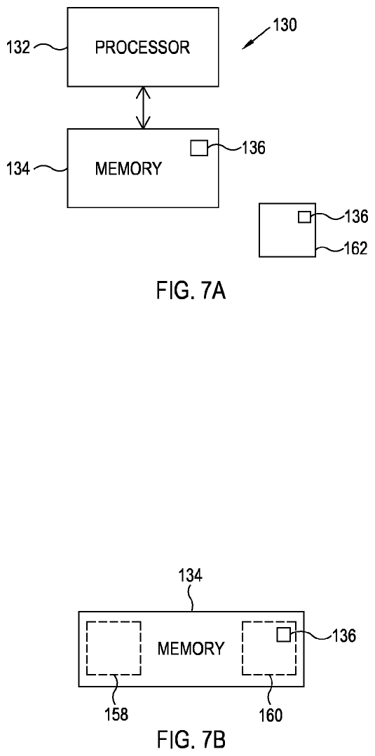

In examples the memory 134 comprises a random access memory 158 and a read only memory 160. In examples the computer program 136 can be stored in the read only memory 158. See, for example, FIG. 8B

Although the processor 132 is illustrated as a single component/circuitry it may be implemented as one or more separate components/circuitry some or all of which may be integrated/removable. The processor 132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus 130 can, in examples, comprise means for:
receiving secondary radio link failure information 164, wherein the secondary radio link failure information 164 is indicative of circumstances of a failure in a secondary radio link between a user equipment 168 and at least one source secondary node 170 while the user equipment 168 was configured to conditionally access at least one target secondary node 166, and the user equipment 168 is having dual connectivity with a source master node 172 and a source secondary node 170;
determining a plurality of suggested target primary cells of a secondary cell group 174 to be prepared by the at least one target secondary node 166 for conditional access by a user equipment 168;
determining, based at least in part on the received secondary radio link failure information 164, assistance information 176, wherein the assistance information 176 assists the at least one target secondary node 166 in determining which at least one of the plurality of suggested target primary cells of a secondary cell group 174 is to be prepared by the at least one target secondary node 166 for conditional access by a user equipment 168; and
transmitting, directly or indirectly, information 178 indicative of the plurality of suggested target primary cells of a secondary cell group 174 and the determined assistance information 176 to the at least one target secondary node 166.

Thus, the apparatus 130 can, in examples, comprise means for:
receiving information 178 indicative of a plurality of suggested target primary cells of a secondary cell group 174 to be prepared by a target secondary node 166 for conditional access by a user equipment 168 and assistance information 176 configured to assist the target secondary node 166 in determining which at least one of the plurality of suggested target primary cells of a secondary cell group 174 is to be prepared by the at least one target secondary node 166 for conditional access by a user equipment 168, wherein the assistance information 176 is determined based at least in part on secondary radio link failure 164 information associated with the target secondary node 166;
determining based, at least in part, on the received assistance information 176, at least one of the plurality of suggested target primary cells of a secondary cell group 174 to be prepared for conditional access by a user equipment 168; and
transmitting, to a master node 172, conditional access configuration information 186 indicative of the determined at least one target primary cell of a secondary cell group.

In examples, an apparatus 130 can comprise means for performing one or more methods, or at least part of one or more methods, as disclosed herein.

In examples, an apparatus 130 can be configured to perform one or more methods, or at least a part of one or more methods, as disclosed herein.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’is used in this document with an inclusive not an exclusive meaning.

That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/we claim:

1. An apparatus comprising:
at least one processor; and
at least one memory storing instructions that, when executed by the at least one processor, cause the apparatus to perform:
receiving secondary radio link failure information, wherein the secondary radio link failure information is indicative of circumstances of a failure in a secondary radio link between a user equipment and at least one source secondary node while the user equipment was configured to conditionally access at least one target secondary node, and the user equipment is having dual connectivity with a source master node and a source secondary node;
determining a plurality of suggested target primary cells of a secondary cell group to be prepared by the at least one target secondary node for conditional access by a user equipment;
determining, based at least in part on the received secondary radio link failure information, assistance information, wherein the assistance information assists the at least one target secondary node in determining which at least one of the plurality of suggested target primary cells of a secondary cell group is to be prepared by the at least one target secondary node for conditional access by a user equipment; and
transmitting, directly or indirectly, information indicative of the plurality of suggested target primary cells of a secondary cell group and the determined assistance information to the at least one target secondary node.

2. The apparatus as claimed in claim 1, wherein the assistance information comprises priority information for the plurality of suggested target primary cells of a secondary cell group for preparation by the at least one target secondary node for conditional access by a user equipment.

3. The apparatus as claimed in claim 1 or 2, wherein the assistance information comprises information indicative of a number of times that the suggested target primary cells of a secondary cell group were the correct choice for conditional access by a user equipment.

4. The apparatus as claimed in any preceding claim, wherein transmitting information indicative of the plurality of suggested target primary cells of a secondary cell group and the determined assistance information comprises transmitting at least one SgNB Change Required message and/or at least one SgNB Addition Request message.

5. The apparatus as claimed in any of claims 1 to 4, wherein the information indicative of the plurality of suggested target primary cells of a secondary cell group comprises at least one cell identity.

6. (canceled)

7. A method comprising:
receiving secondary radio link failure information, wherein the secondary radio link failure information is indicative of circumstances of a failure in a secondary radio link between a user equipment and at least one source secondary node while the user equipment was configured to conditionally access at least one target secondary node, and the user equipment is having dual connectivity with a source master node and a source secondary node;
determining a plurality of suggested target primary cells of a secondary cell group to be prepared by the at least one target secondary node for conditional access by a user equipment;
determining, based at least in part on the received secondary radio link failure information, assistance information, wherein the assistance information assists the at least one target secondary node in determining which at least one of the plurality of suggested target primary cells of a secondary cell group is to be prepared by the at least one target secondary node for conditional access by a user equipment; and
transmitting, directly or indirectly, information indicative of the plurality of suggested target primary cells of a secondary cell group and the determined assistance information to the at least one target secondary node.

8. The method as claimed in claim 7, wherein the assistance information comprises priority information for the plurality of suggested target primary cells of a secondary cell group for preparation by the at least one target secondary node for conditional access by a user equipment.

9. The method as claimed in claim 7 or 8, wherein the assistance information comprises information indicative of a number of times that the suggested target primary cells of a secondary cell group were the correct choice for conditional access by a user equipment.

10. The method as claimed in any of claims 7 to 9, wherein transmitting information indicative of the plurality of suggested target primary cells of a secondary cell group and the determined assistance information comprises transmitting at least one SgNB change required message and/or at least one SgNB Addition Request message.

11. The method as claimed in any of claims 7 to 10, wherein the information indicative of the plurality of suggested target primary cells of a secondary cell group comprises at least one cell identity.

12-16. (canceled)

17. An apparatus comprising:
at least one processor; and
at least one memory storing instructions that, when executed by the at least one processor, cause the apparatus to perform:
receiving information indicative of a plurality of suggested target primary cells of a secondary cell group to be prepared by a target secondary node for conditional access by a user equipment and assistance information configured to assist the target secondary node in determining which at least one of the plurality of suggested target primary cells of a secondary cell group is to be prepared by the at least one target secondary node for conditional access by a user equipment, wherein the assistance information is determined based at least in part on secondary radio link failure information associated with the target secondary node; and
determining based, at least in part, on the received assistance information, at least one of the plurality of suggested target primary cells of a secondary cell group to be prepared for conditional access by a user equipment; and
transmitting, to a master node, conditional access configuration information indicative of the determined at least one target primary cell of a secondary cell group.

18. The apparatus as claimed in claim 17, wherein the assistance information comprises priority information for the plurality of suggested target primary cells of a secondary cell group for preparation by the at least one target secondary node for conditional access by a user equipment.

19. The apparatus as claimed in claim 17 or 18, wherein the assistance information comprises information indicative of a number of times that the suggested target primary cells of a secondary cell group were the correct choice for conditional access by a user equipment.

20. The apparatus as claimed in any of claims 17 to 19, wherein receiving the information indicative of the plurality of suggested target primary cells of a secondary cell group and the assistance information comprises receiving at least one SgNB Addition Request message.

21. The apparatus as claimed in any of claims 17 to 20, wherein the assistance information is originated by a source master node or a source secondary node.

22.-31. (canceled)
